(19) United States
(12) Patent Application Publication
(10) Pub. No.: US 2007/0039491 A1
(43) Pub. Date: Feb. 22, 2007

(54) Moistening device for a roll or a cylinder of an offset press

(75) Inventors: Alfons Grieser, Sielenbach (DE); Georg Schmid, Neusaess (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsburg (DE)

(21) Appl. No.: 11/481,689

(22) Filed: Jul. 6, 2006

(30) Foreign Application Priority Data
Jul. 7, 2005 (DE) 10 2005 031 837.1

(51) Int. Cl. B41L 25/00

(52) U.S. Cl. 101/147

(57) ABSTRACT

A moistening device for a roll or a cylinder of an offset press is disclosed. The moistening device includes a chamber-type doctor which is attached for moistening to the roll or to the cylinder. At least one actuator is arranged on the chamber-type doctor, with which actuator the pressing force of the chamber-type doctor on the roll or the cylinder can be varied along the length of the roll or the cylinder.

This application claims the priority of German Patent Document No. 10 2005 031 837.1, filed Jul. 7, 2005, the disclosure of which is expressly incorporated by reference herein.

### BACKGROUND AND SUMMARY OF THE INVENTION

The invention relates to a moistening device for a roll or a cylinder of an offset press.

Moistening devices of printing presses, which are also denoted by damping unit, meter the required amount of damping solution for the plate cylinder. The damping solution is usually transferred to the plate cylinder via an arrangement of a plurality of rolls.

Different embodiments of moistening devices are known from the prior art. For example, German Patent Document No. DD WP 15d/16788 discloses a damping unit for planographic presses, in which the ductor roll rotates partly with its circumferential surface in a water container, in which the damping solution is situated. Here, a doctor which bears against the ductor roll strips excess damping solution which is received by the ductor roll off, before the damping solution is transferred to the plate cylinder by means of two damping rollers.

International Publication No. WO 99/01282 discloses a further moistening device for a ductor roll, in which the damping solution is applied to the ductor roll by a chamber-type doctor and is then transferred to the plate cylinder via a further roll.

In the devices which are described in WP 15d/16788 and WO 99/01282, the amount of damping solution can be set via the arrangement of the rolls, the number of rolls, the roll diameter, the surface material of the roll and the roll pressure. However, the requirement for damping solution can vary to a pronounced effect in zones along the length of the plate cylinder as a function of the subject, e.g., the print medium or paper web. In the known moistening devices, this varying requirement for damping solution is usually achieved by a change in the roll adjustment, for example by pressing or offsetting the rolls. However, roll adjustment of this type is complicated and the result of the zonal damping-solution setting is only unsatisfactory here. Moreover, roll adjustment can achieve only an approximation of the required optimum damping-solution profile over the width of the roll.

It is therefore an object of the invention for it to be possible to set the metering of the amount of damping solution along the length of the roll or the cylinder in an improved manner.

Proceeding from this, the present invention is based on the problem of providing an improved moistening device for a roll or a cylinder of an offset press, which moistening device can meter the amount of damping solution in the individual zones along the length of the roll or the cylinder more accurately.

According to the invention, the moistening device for a roll or a cylinder of an offset press has a chamber-type doctor which is attached for moistening to the roll or to the cylinder. Here, the chamber-type doctor has at least one actuator, with which the pressing force of the chamber-type doctor on the roll or the cylinder can be varied along the length of the roll or the cylinder.

If moisture is applied to the surface of the roll or of the cylinder via the chamber-type doctor, the film thickness of the damping solution can be reduced by a corresponding increase in the pressing force and, vice versa, an increase in the film thickness of the damping solution can be achieved by a reduction in the pressing force. An improved and more accurate setting of the film of damping solution along the roll or the cylinder is therefore made possible. This setting method can be implemented more quickly than the previously required and complicated roll adjustment.

Furthermore, the following disadvantages can be avoided by the invention, compared with the known moistening devices having a chamber-type doctor, in which setting of the damping solution along the length of the roll or the cylinder is not possible.

A partial excess of damping solution which is usually associated with further disadvantages, such as density loss or over-emulsification, can be avoided, for example. Although emulsification is necessary within a defined damping-solution window or in a defined damping-solution region in the offset process, an excess of damping solution leads to undesirable excessive emulsification, what is known as over-emulsification. This over-emulsification has a negative influence on the rheological properties of the ink, such as spray properties, density and naked running properties.

Naked running of the rolls, which often occurs on account of an excessive damping-solution content, can also be suppressed by the invention, however. An excessively high damping-solution content on hydrophobic surfaces, such as the surface of a ceramic roll, leads to rejection of the ink. If required, the amount of damping solution can be adapted zonally and therefore naked running can be prevented by the metered application of damping solution.

The moistening device can be attached both directly to applicator rolls and also to the plate cylinder.

In one advantageous embodiment of the moistening device, the chamber-type doctor is divided along the length of the roll or the cylinder into zones, at least one actuator being arranged per zone. The more zones and actuators made available over the width of the printing press, the more finely and more accurately the amount of damping solution can be set along the length of the roll or the cylinder. As a result, different partial circumferential surfaces of the roll or cylinder surface can be wetted to a different extent with the damping solution.

It is favourable if the chamber-type doctor has elastic connecting points between the zones. This can achieve the situation where an introduction of force of the actuator to a zone of the chamber-type doctor does not act on the adjacent zone of the chamber-type doctor. As a result, this therefore achieves mechanical decoupling of the adjacent zones of the chamber-type doctor. Here, the elastic connecting points can be realized by material cut-outs in the chamber-type doctor. As a result, the flexural rigidity of the chamber-type doctor is reduced at the locations of the material cut-out. However, as an alternative, elastic materials can also be incorporated between the zones of the chamber-type doctor. Elastomeric materials, for example, are suitable for this purpose.

The chamber-type doctor can be mounted movably in a housing or frame, the at least one actuator exerting a force between the chamber-type doctor and the housing or frame. For example, the housing or the frame can be configured as a U-shaped rail, in which the actuator or the actuators is/are arranged in the connecting region of the U-limbs. Here, the chamber-type doctor can be arranged between the U-limbs and can move along the limb length. As a result of the compact design of the housing or frame, the chamber-type doctor is configured as a unit, in order for it to be possible optionally for moistening devices having a non-adjustable chamber-type doctor to be retrofitted simply.

In particular, electric and/or pneumatic and/or hydraulic drives are suitable as actuators. For example, compression and/or tension cylinders are therefore suitable as actuators. However, piezoelectric elements which achieve the required pressing force of the chamber-type doctor on the roll or the cylinder are also suitable for this purpose.

As an alternative or in addition to this, air bellows or fluid bladders may be actuators. These air bellows or fluid bladders can be arranged in such a way that, when the bellows or bladders are filled with air or a gaseous substance or a fluid medium, the expanding bellows or bladders exert a force between the housing or the frame and the chamber-type doctor. A force of 10,000 Newtons on a surface area of one square meter can be achieved with a pressure difference between the interior of the air bellows or fluid bladder and the surrounding air pressure of one bar.

However, the at least one actuator can also be realized by at least one electromagnet which, for example, attracts or repels a magnetic or ferromagnetic material which is arranged on the chamber-type doctor. As the electromagnet is not in contact with the material of identical or opposite magnetic polarity, a contactless introduction of force to the chamber-type doctor can be achieved.

The chamber-type doctor can have at least one sealing element in the contact region of the roll or of the cylinder. The sealing element can be configured as a plastic or metal sealing ring. Here, the sealing element can extend in a groove which is made on the underside of the chamber-type doctor or on the housing or frame. The outlet-side seal of the chamber-type doctor is particularly relevant, because the thickness of the film of damping solution is set by the former.

It is advantageous if at least one scraper doctor is attached to the housing or the frame. Contaminants which are situated on the roll or the cylinder can be stripped off by this scraper doctor, with the result that the contamination of the sealing element is avoided as far as possible. In order to doctor off the metered film of damping solution, in each case one scraper doctor can be attached to the housing or to the frame in the rotational direction and/or counter to the rotational direction of the roll or the cylinder. In this way, the film on the roll or cylinder surface is doctored before entry into the moistening region of the chamber-type doctor and after leaving the chamber-type doctor.

In order to distribute the damping solution homogeneously onto the roll or cylinder surface, it is favourable if the chamber-type doctor forms a hollow space in the contact region of the roll or of the cylinder, into which hollow space the damping solution can be introduced under pressure via one or more openings.

Furthermore, it should be made possible to determine the actually acting pressing force of the chamber-type doctor on the roll or cylinder surface. This can be achieved by sensors, preferably pressure sensors, which are attached to the actuators and/or to the chamber-type doctor. Furthermore, regulation or control of the actuators can be made possible via the sensors.

The rolls or the cylinder should be of oscillating configuration, that is to say a movement in the axial direction is to be ensured. As a result, the formation of longitudinal stripes of damping solution which can occur in the region between the zones can be avoided.

In order for it to be possible to determine the metered amount of damping solution and in order for it to be possible optionally to carry out regulation or control of the actuators, a sensor, preferably a damping-solution sensor, is arranged on the damping-solution outlet of the chamber-type doctor, on the damping-solution applicator unit or on the plate cylinder in one embodiment of the invention.

Furthermore, it is advantageous to supply every zone with a dedicated damping-solution supply. As a result, the zonal amount of damping solution can be set quickly and independently, the precise amount of damping solution being metered via the setting pressure of the doctor.

### BRIEF DESCRIPTION OF THE DRAWINGS

Exemplary embodiments of the invention will be explained in greater detail using the drawings, without being restricted thereto. In the drawings:

FIG. 1 shows a sectional view through a chamber-type doctor and a ductor roll, perpendicularly with respect to the ductor-roll axis;

FIG. 2 shows a sectional view through the chamber-type doctor from FIG. 1, through the ductor roll along the ductor-roll longitudinal axis; and

FIG. 3 shows a sectional view through a chamber-type doctor, along the ductor-roll longitudinal axis with a different design of the actuator.

### DETAILED DESCRIPTION OF THE DRAWINGS

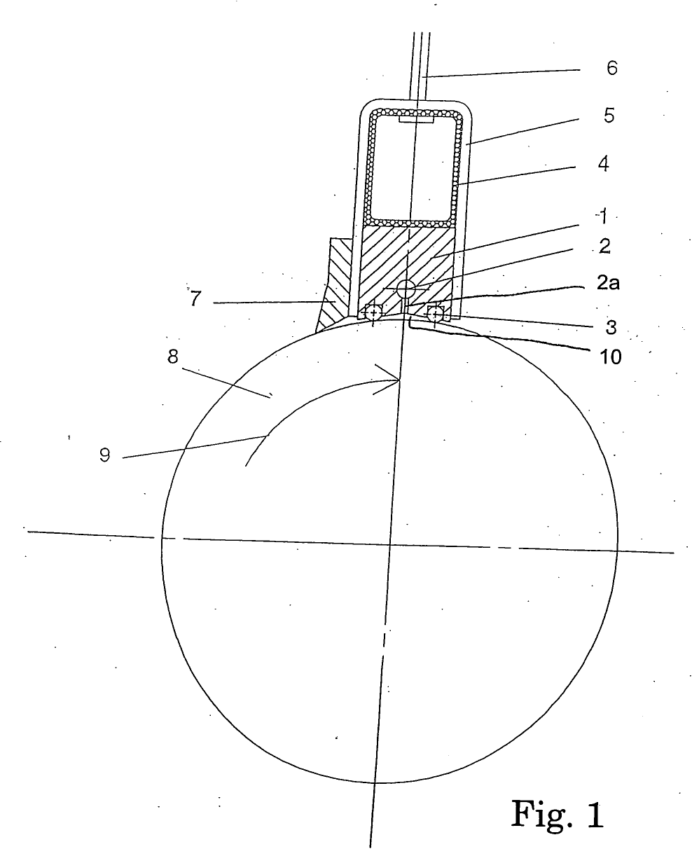

In the following text, the present invention will be described in greater detail with reference to FIGS. 1 to 3.

FIG. 1 shows a section through the chamber-type doctor 1, through the doctor housing 5 and the ductor roll 8, perpendicularly with respect to the ductor roll 8. The chamber-type doctor 1 is mounted such that it can move in the vertical direction between the limbs of the doctor housing 5 which is U-shaped in this embodiment. A pressure bellows 4 is situated above the chamber-type doctor 1, which pressure bellows 4 can optionally be filled with, and also emptied of, a gaseous or liquid medium via the pressure connection 6, with the result that the contact pressure of the chamber-type doctor 1 on the ductor roll 8 can be varied. The thickness of the moisture film on the ductor-roll surface is set by this change in the contact pressure of the chamber-type doctor 1 on the ductor roll 8, a pressure increase reducing the thickness of the moisture film and, vice versa, a pressure drop increasing the thickness of the moisture film. A sealing element 3 is situated in the contact region of the chamber-type doctor 1 and the ductor roll 8, which sealing element 3 is mounted within a groove in this embodiment and seals a hollow space 10 between the chamber-type doctor 1 and the ductor roll 8. The damping solution is fed in via the damping-solution feed line 2 in this hollow space 10, and is introduced into the hollow space 10 via openings on the underside of the chamber-type doctor 1. A scraper doctor 7 is arranged on the left-hand side of the doctor housing 5, which scraper doctor 7 strips off contaminants which are possibly situated on the ductor roll 8 in the rotational direction 9 of the ductor roll 8 in the clockwise direction, and thus avoids contamination of the sealing element 3.

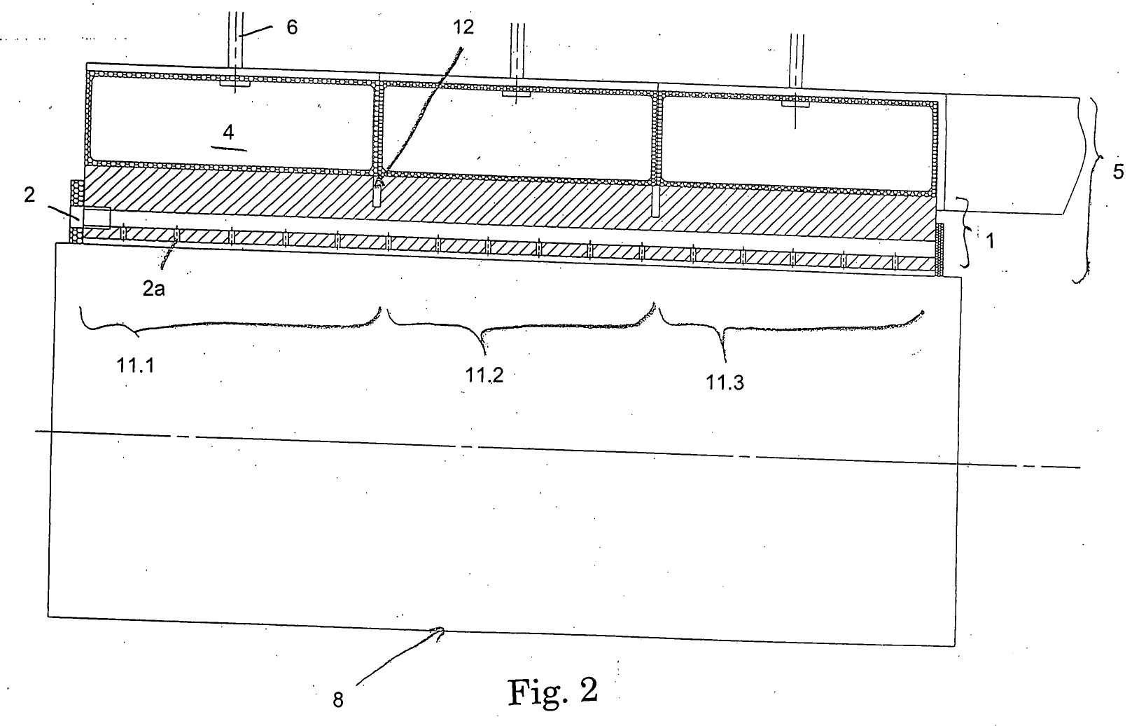

FIG. 2 shows a sectional view through the chamber-type doctor 1 from FIG. 1, along the longitudinal axis of the ductor roll 8. In order for it to be possible to meter the moisture variably along the circumferential surface on the ductor roll 8, the chamber-type doctor 1 is divided into zones 11.1 to 11.x, the chamber-type doctor 1 from FIG. 2 having three zones 11.1 to 11.3. In this embodiment, in each case one air bellows 4 is used per zone between the housing 5 and the zone 11.1 to 11.x of the chamber-type doctor 1. As a result of the air bellows 4, a homogeneous introduction of the pressure or of the force to the surface of the respective zone 11.1 to 11.x can be achieved. In order that an introduction of force, for example to the zone 11.1, does not act, or virtually does not act, on the zone 11.2, adjacent zones 11.1 to 11.x have elastic regions 12 in the intermediate region. In this embodiment of the chamber-type doctor 1, the elastic regions 12 are realized by a material cut-out or material constriction in the chamber-type doctor 1, which lowers the flexural rigidity.

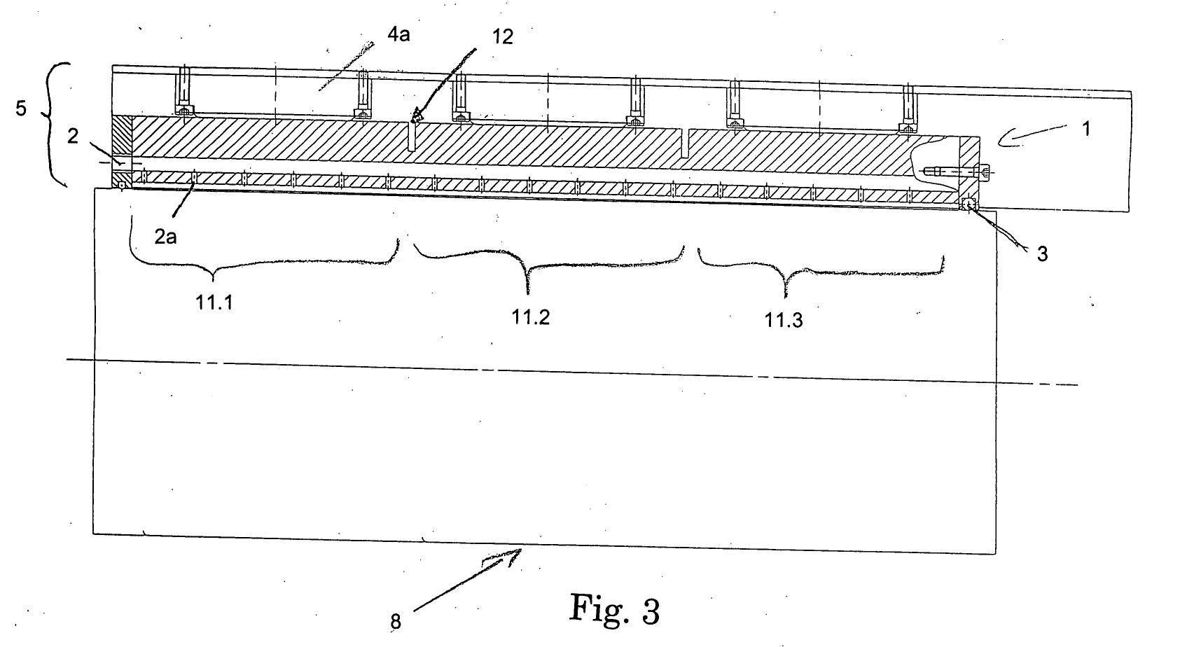

In the same sectional view, FIG. 3 shows the construction of a further chamber-type doctor 1. In contrast to the actuators of the chamber-type doctor 1 from FIG. 2, which are configured as pressure bellows, in each case one compression cylinder 4a is used between the housing 5 and the chamber-type doctor 1 per zone 11.1 to 11.x in FIG. 3.

It is noted that, in a deviation from the embodiments shown, it is also possible to arrange a plurality of actuators per zone 11.1 to 11.x which can then optionally exert locally different forces or pressures on a zone 11.1 to 11.x.

Furthermore, it is noted that, in a deviation from the embodiments shown, every zone 11.1 to 11.x can have a dedicated damping-solution supply 2 and an individual number of holes or slots 2a, in order to carry out more accurate and more targeted metering of the damping solution per zone 11.1 to 11.x as a result.

It goes without saying that the abovementioned features and the features of the claims can be used not only in the respectively specified combinations, but also in other combinations or alone, without departing from the scope of the invention. Further, the foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS

1 Chamber-type doctor

2 Damping-solution feed line

2a Hole/slot

3 Sealing element

4 Pressure bellows (air/liquid)

4a Compression cylinder

5 Doctor housing

6 Pressure connection

7 Scraper doctor

8 Ductor roll

9 Rotational direction

10 Hollow space

11.1-11.x Zone 1 to zone x

12 Elastic region

What is claimed is:

1. A moistening device for a roll or a cylinder of an offset press, comprising a chamber-type doctor which is attached for moistening to the roll or to the cylinder, wherein at least one actuator is arranged in an interior of, or outside, the chamber-type doctor, with which actuator a pressing force of the chamber-type doctor on the roll or the cylinder is varied along a length of the roll or the cylinder.

2. The moistening device according to claim 1, wherein the roll is an applicator roll or a ductor roll.

3. The moistening device according to claim 1, wherein the cylinder is a plate cylinder.

4. The moistening device according to claim 1, wherein the chamber-type doctor is divided along the length of the roll or the cylinder into zones and wherein at least one actuator is arranged per zone.

5. The moistening device according to claim 4, wherein the chamber-type doctor has elastic connecting points between the zones.

6. The moistening device according to claim 5, wherein the elastic connecting points are formed by material cut-outs of the chamber-type doctor and/or by an incorporation of elastic materials in the chamber-type doctor.

7. The moistening device according to claim 1, wherein the chamber-type doctor is mounted movably in a housing or frame, the at least one actuator exerting a force between the chamber-type doctor and the housing or frame.

8. The moistening device according to claim 1, wherein the at least one actuator has an electric and/or pneumatic and/or hydraulic drive.

9. The moistening device according to claim 1, wherein the at least one actuator is formed by at least one compression and/or tension cylinder.

10. The moistening device according to claim 1, wherein the at least one actuator is formed by at least one air bellows or fluid bladder.

11. The moistening device according to claim 1, wherein the at least one actuator is formed by at least one electromagnet.

12. The moistening device according to claim 1, wherein the chamber-type doctor has at least one sealing element in a contact region of the roll or of the cylinder.

13. The moistening device according to claim 7, wherein at least one scraper doctor is attached to the housing or the frame.

14. The moistening device according to claim 1, wherein the chamber-type doctor forms a hollow space in a contact region of the roll or of the cylinder, into which hollow space a damping solution is introducible under pressure via one or more openings.

15. The moistening device according to claim 1, wherein a sensor is arranged on the actuator and/or the chamber-type doctor, which sensor determines the pressing force and supplies a signal for regulation or control of the actuator.

16. The moistening device according to claim 1, wherein the roll or the cylinder is of an oscillating configuration.

17. The moistening device according to claim 1, wherein a damping-solution sensor is arranged on a damping-solution outlet of the chamber-type doctor, on a damping-solution applicator unit and/or on a plate cylinder, which sensor determines a metered amount of damping solution and supplies a signal for regulation or control of the actuator.

18. The moistening device according to claim 4, wherein each of the zones has a dedicated damping-solution supply.

19. A moistening device for an offset press, comprising:
a housing;
a chamber-type doctor disposed within the housing, wherein a lower portion of the chamber-type doctor is disposed adjacent to a ductor roll; and
an actuator disposed within the housing and in operable engagement with the chamber-type doctor, wherein the actuator applies a pressure force to the chamber-type doctor such that a contact pressure is applied by the lower portion of the chamber-type doctor to the ductor roll along a length of the ductor roll.

20. The moistening device according to claim 19, wherein the pressure force is variable along the length of the ductor roll.
